(19) United States
(12) Patent Application Publication
(10) Pub. No.: US 2026/0107117 A1
(43) Pub. Date: Apr. 16, 2026

(54) MOTION DETECTION AND ZONE AMBIGUITY RESOLUTION

(71) Applicant: Samsung Electronics Co., Ltd., Suwon-si (KR)

(72) Inventors: Rebal Al Jurdi, Allen, TX (US); Boon Loong Ng, Plano, TX (US); Yuming Zhu, Plano, TX (US)

(21) Appl. No.: 19/336,429

(22) Filed: Sep. 22, 2025

Related U.S. Application Data
(60) Provisional application No. 63/706,440, filed on Oct. 11, 2024.
(60) Provisional application No. 63/739,428, filed on Dec. 27, 2024.

(51) Int. Cl. H04W 4/38; H04B 7/06; H04B 17/318; H04L 41/16

(52) U.S. Cl. CPC H04W 4/38; H04B 7/0626; H04B 17/318; H04L 41/16

(57) ABSTRACT

Methods and systems for motion detection and zone ambiguity resolution. A method includes receiving multiple signals at a first access point (AP) from a second AP using a single wireless link, detecting motion based on the multiple signals, and identifying, using one or more Wi-Fi received signal strength indicators (RSSIs), a zone as having motion from a user device, the zone being one of multiple zones spanned by the single wireless link.

### CROSS-REFERENCE TO RELATED APPLICATIONS AND CLAIM OF PRIORITY

The present application claims priority to U.S. Provisional Patent Application No. 63/706,440, filed on Oct. 11, 2024 and U.S. Provisional Patent Application No. 63/739,428, filed on Dec. 27, 2024. The contents of the above-identified patent documents are incorporated herein by reference.

### TECHNICAL FIELD

The present disclosure relates generally to wireless communication systems. more specifically, the present disclosure relates to a system and method for motion detection and zone ambiguity resolution including device-free motion detection and zone ambiguity resolution.

### BACKGROUND

Wireless fidelity (Wi-Fi) Sensing uses Wi-Fi signals to detect and track people or objects within a specific area by analyzing the reflections and attenuations of Wi-Fi signals as they reflect off of, and diffract around, different surfaces and obstacles. By monitoring these changes over time, Wi-Fi sensing is used to infer the presence, location, and movement of objects within the coverage area. Wi-Fi Sensing has a wide range of applications and use cases across various industries due to its ability to gather information about the environment and the activities occurring within it without requiring physical contact or wearable devices.

### SUMMARY

The present disclosure relates generally to wireless communication systems and, more specifically, various embodiments of the present disclosure relates to a system and method for device-free motion detection and zone ambiguity resolution.

In one embodiment, a method is provided. The method includes receiving multiple signals at a first access point (AP) from a second AP using a single wireless link, detecting motion based on the multiple signals, and identifying, using one or more Wi-Fi received signal strength indicators (RSSIs), a zone as having motion from a user device, the zone being one of multiple zones spanned by the single wireless link.

In another embodiment, an electronic device is provided. The electronic device includes a transceiver, and a processor operably coupled to the transceiver. The processor is configured to receive multiple signals at a first AP from a second AP using a single wireless link. The processor is also configured to cause the electronic device to detect motion based on a Wi-Fi RTT of the multiple signals. The processor is further configured to cause the electronic device to identify, using one or more Wi-Fi RSSIs, a zone as having motion from a user device, the zone being one of multiple zones spanned by the single wireless link.

In yet another embodiment, a non-transitory computer-readable medium is provided. The non-transitory computer-readable medium includes program code, that when executed by at least one processor of an electronic device, causes the electronic device to receive multiple signals at a first AP from a second AP using a single wireless link, detect motion based on a Wi-Fi RTT of the multiple signals, and identify, using one or more Wi-Fi RSSIs, a zone as having motion from a user device, the zone being one of multiple zones spanned by the single wireless link.

Other technical features may be readily apparent to one skilled in the art from the following figures, descriptions, and claims. Detecting motion based on the Wi-Fi RTT of the multiple signals may include determining whether a ratio of a maximum Wi-Fi round-trip time (RTT) distance of the multiple signals to an average Wi-Fi RTT distance of the multiple signals exceeds a specified threshold. Identifying the zone may include detecting that a motion has occurred using a motion detection algorithm based on the one or more Wi-Fi RSSIs, sorting the one or more Wi-Fi RSSIs at different antennas of the first AP and the second AP, determining an ordering for the different antennas, and determining the zone by comparing the ordering for the different antennas against a reference. Detecting motion based on the Wi-Fi RTT of the multiple signals may include receiving data from the multiple signals including at least one of a channel state information (CSI) magnitude, a CSI phase, or a Wi-Fi RSSI, transforming the data into one or more preliminary features, producing one or more refined features from one or more preliminary features, and generating motion detection result based on the one or more refined features using a machine learning model. Producing one or more refined features from one or more preliminary features over a sliding window may include transforming the data into the one or more preliminary features using a first statistical function over the sliding window and transforming the one or more preliminary features into the one or more refined features using a second statistical function over a second sliding window. Producing one or more refined features from one or more preliminary features over a sliding window may include stacking the one or more refined features into a matrix feature or tensor feature and generating a motion detection result based on the matrix feature or the tensor feature using a machine learning model. The machine learning model may be trained using the one or more refined features in a supervised learning classification model.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point according to various embodiments of the present disclosure;

FIG. 2B illustrates an example station according to various embodiments of this disclosure;

FIG. 3 illustrates an example device-free motion detection and zone ambiguity resolution system according to embodiments of the present disclosure;

FIGS. 4A-4C illustrate an example fine timing measurement process of the device-free motion detection and zone ambiguity resolution system of FIG. 3 according to embodiments of the present disclosure; and

FIG. 5 illustrates an example flow chart of a method for motion detection and zone ambiguity resolution according to embodiments of the present disclosure.

### DETAILED DESCRIPTION

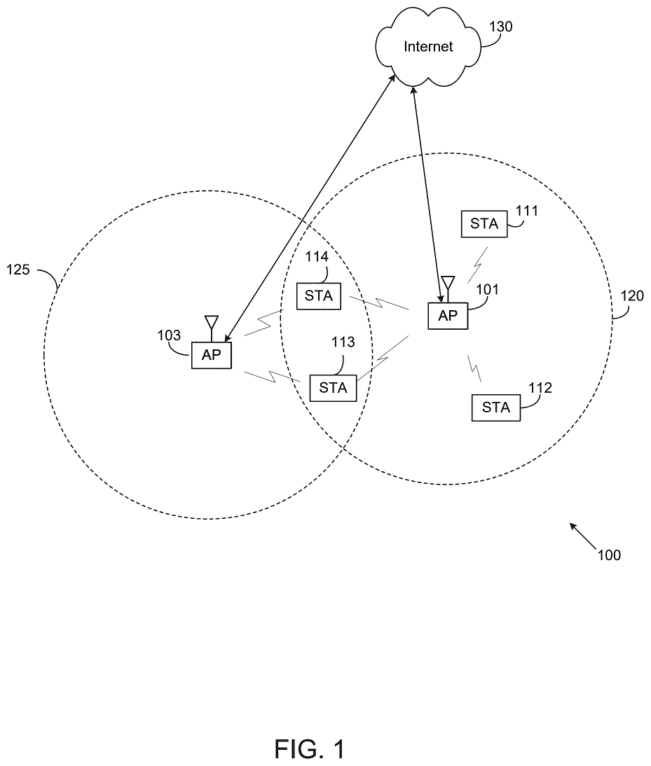

FIG. 1 through FIG. 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, Wi-Fi Sensing uses Wi-Fi signals to detect and track people or objects within a specific area by analyzing the reflections and attenuations of Wi-Fi signals as they reflect off of, and diffract around, different surfaces and obstacles. By monitoring these changes over time, Wi-Fi sensing is used to infer the presence, location, and movement of objects within the coverage area. Wi-Fi Sensing has a wide range of applications and use cases across various industries due to its ability to gather information about the environment and the activities occurring within it without requiring physical contact or wearable devices.

For example, Wi-Fi sensing may be used for motion detection to detect movement by analyzing changes in the Wi-Fi signal as it interacts with objects and people, which can be used for security systems, monitoring elderly individuals, or tracking movement in smart homes. Other uses for Wi-Fi sensing include gesture recognition, health monitoring, occupancy detection, intrusion detection, and retail analytics.

Wi-Fi sensing belongs to the broader umbrella of wireless sensing which encompasses a variety of other technologies (such as Bluetooth low energy, ultra-wideband, and radio frequency identification), most of which were originally meant for communications, each with its own unique capabilities and applications. For motion detection, Wi-Fi sensing offers several advantages compared to other sensing technologies. The ubiquity of both its networks and devices in homes, offices, and public spaces allows for easy implementation without the need for additional infrastructure. This widespread availability makes Wi-Fi sensing a cost-effective solution, as it uses existing hardware rather than requiring new devices or systems, enabling two wireless applications at the same time: communications and sensing. Additionally, Wi-Fi sensing provides rich data insights by analyzing movement patterns and occupancy trends, offering valuable information for optimizing energy use and enhancing security in various environments.

Wi-Fi sensing may include device-free sensing which, unlike device-based positioning, relies on methods that may not be accurate. In device-based methods, dedicated RF receivers, tags or sensors are used to emit unique signals that can be easily detected by neighboring receivers. However, in device-free methods, there are no such dedicated devices involved. Instead, these methods rely on existing wireless infrastructure, such as Wi-Fi access points, to sense the presence and movement of objects through subtle changes in the wireless signals.

However, some Wi-Fi sensing techniques may encounter location ambiguity when the sidedness of a user or an object of interest is ambiguous, similar to a phenomenon sometimes referred to as flip ambiguity in localization, and occurs when the number of measurements needed to localize an object is below a predetermined threshold. Location ambiguity may occur during motion detection, where the objective is to identify, among a set of zones spanned by one or more wireless links, the particular zone or zones exhibiting motion. This makes motion detection significantly more difficult when multiple zones are spanned by a single wireless link.

For example, a zone map may include two zones (two rooms), two Wi-Fi access points, one per room, and one wireless link. If motion is detected across the link through simple motion detection methods, such as the signal fluctuation, then it could be attributed to motion in either of the two zones, leading to zone ambiguity defined as ambiguity in the location of the user or object of interest among zones of a zone map.

Accordingly, the present disclosure provides systems and methods for motion detection and zone ambiguity resolution. As described herein, the present disclosure includes systems and methods that detects motion, for example, based on a Wi-Fi round-trip time (RTT), received signal strength indicators (RSSIs), or channel state information (CSI), of the multiple signals and identifies, using one or more Wi-Fi RSSIs, a zone as having motion from a user that is spanned by the single wireless link. This disclosure provides a motion detection method that uses a Wi-Fi round-trip time (RTT) mechanism supported by current wireless mobile devices and infrastructure. Additionally, the method uses Wi-Fi RSSI to resolve zone ambiguity, that is, to determine the correct zone the user is moving in out of a set of zones spanned by the same wireless link.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of the present disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111, 112, 113, and 114 within a coverage area 120 of the AP 101. The APs 101-103 may communicate with each other and with the STAs 111-114 using Wi-Fi, Ultra-Wide Band (UWB), or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for estimating a user velocity based on multi-antenna Wi-Fi signals in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

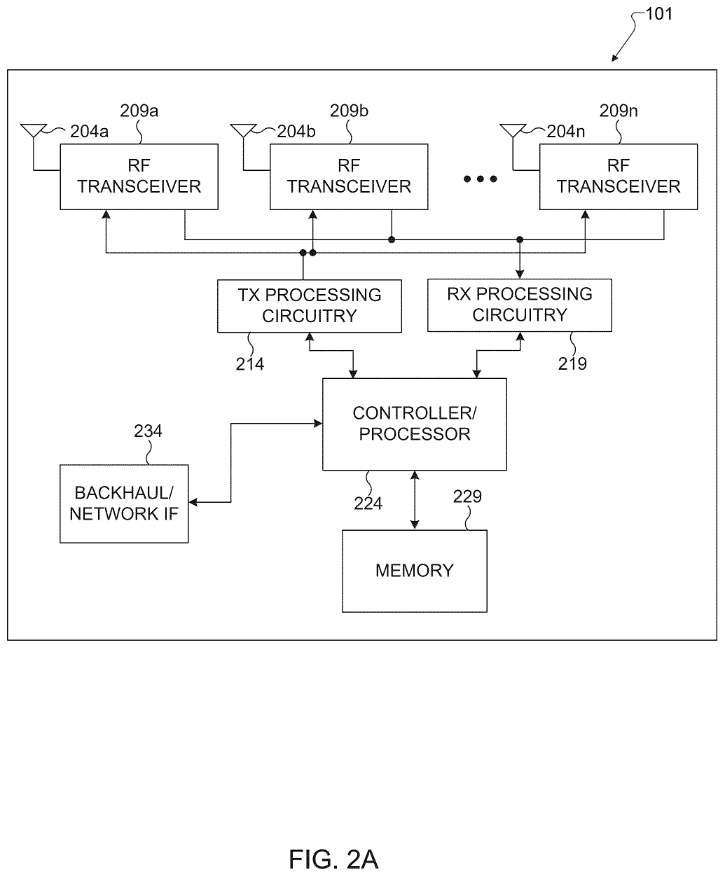

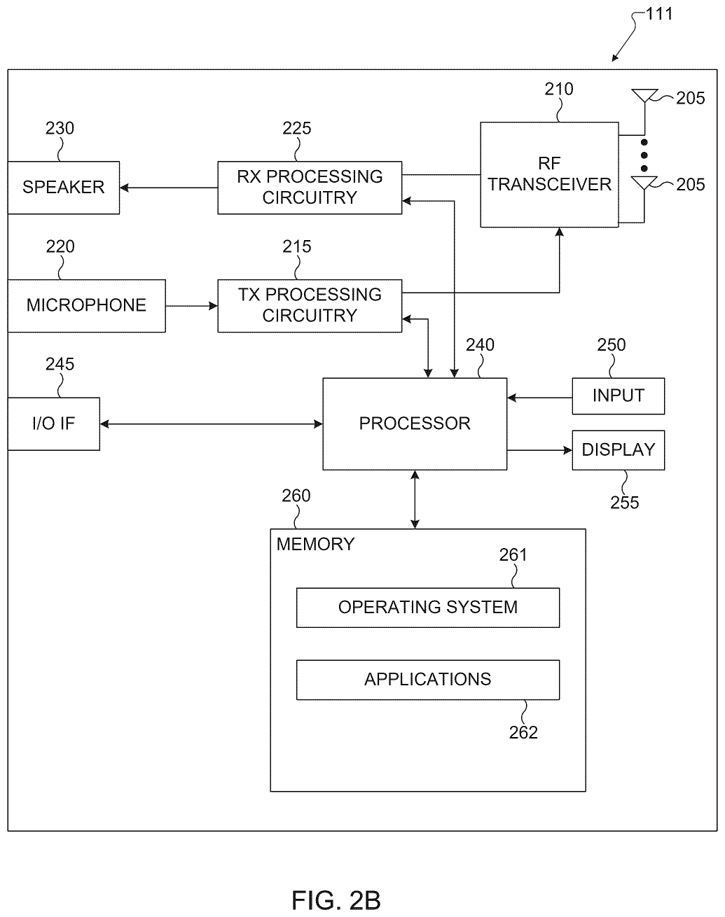

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of the present disclosure to any particular implementation of an AP.

The AP 101 includes multiple antennas 204a-204n, multiple RF transceivers 209a-209n, transmitter processing circuitry 214, and receiver processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the receiver processing circuitry 219, which generates processed baseband signals by filtering, decoding, and/or digitizing the baseband or IF signals. The receiver processing circuitry 219 transmits the processed baseband signals to the controller/processor 224 for further processing.

The transmitter processing circuitry 214 receives analog or digital data (such as voice data, web data, e-mail, or interactive video game data) from the controller/processor 224. The transmitter processing circuitry 214 encodes, multiplexes, and/or digitizes the outgoing baseband data to generate processed baseband or IF signals. The RF transceivers 209a-209n receive the outgoing processed baseband or IF signals from the transmitter processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the receiver processing circuitry 219, and the transmitter processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including estimating a user velocity based on multi-antenna Wi-Fi signals. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as provided by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for estimating a user velocity based on multi-antenna Wi-Fi signals. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of transmitter processing circuitry 214 and a single instance of receiver processing circuitry 219, the AP 101 could include multiple instances of each (such as one per RF transceiver). Alternatively, only one antenna and RF transceiver path may be included, such as in APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of the present disclosure to any particular implementation of a STA.

The STA 111 includes antenna(s) 205, a radio frequency (RF) transceiver 210, transmitter processing circuitry 215, a microphone 220, and receiver processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the receiver processing circuitry 225, which generates a processed baseband signal by filtering, decoding, and/or digitizing the baseband or IF signal. The receiver processing circuitry 225 transmits the processed baseband signal to the speaker 230 (such as for voice data) or to the controller/processor 240 for further processing (such as for web browsing data).

The transmitter processing circuitry 215 receives analog or digital voice data from the microphone 220 or other outgoing baseband data (such as web data, e-mail, or interactive video game data) from the controller/processor 240. The transmitter processing circuitry 215 encodes, multiplexes, and/or digitizes the outgoing baseband data to generate a processed baseband or IF signal. The RF transceiver 210 receives the outgoing processed baseband or IF signal from the transmitter processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the receiver processing circuitry 225, and the transmitter processing circuitry 215 in accordance with well-known principles. In some embodiments, the controller/processor 240 includes at least one microprocessor or microcontroller.

The controller/processor 240 is also capable of executing other processes and programs resident in the memory 260, such as operations for determining a position of a tag based on anchor signals. The controller/processor 240 can move data into or out of the memory 260 as provided by an executing process. In some embodiments, the controller/processor 240 is configured to execute a plurality of applications 262. The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

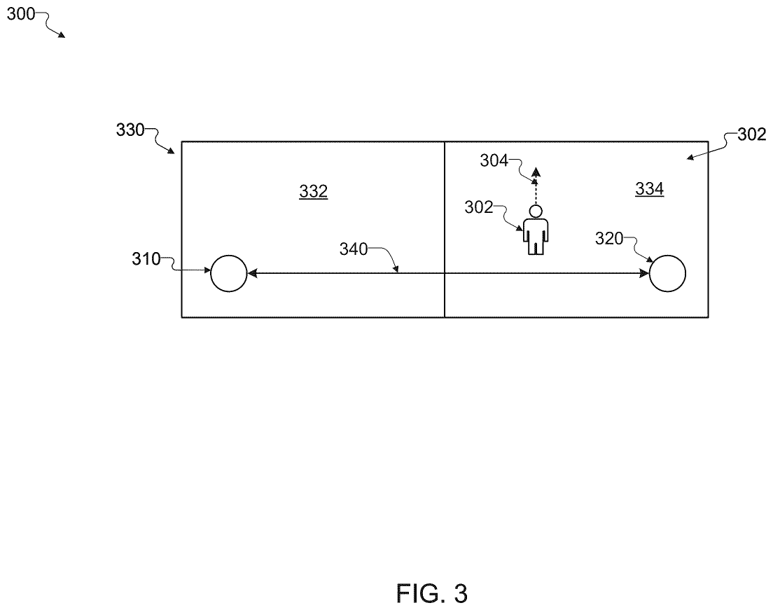

The AP 101 (or the STA 111) may also be configured for motion detection and zone estimation while resolving zone ambiguity. For example, the AP 101 may be part of a motion detection system that detects motion using a single link, as shown in FIG. 3.

FIG. 3 illustrates an example device-free motion detection system 300 according to embodiments of the present disclosure. For ease of explanation, the device-free motion detection system 300 will be described as including one or more components of the wireless network 100 of FIG. 1; however, the device-free motion detection system 300 could be implemented using any other suitable device or system. The embodiment of the device-free motion detection system 300 shown in FIG. 3 is for illustration only. Other embodiments of the device-free motion detection system 300 could be used without departing from the scope of this disclosure.

As shown in FIG. 3, the device-free motion detection system 300 includes a first access point 310 and a second access point 320 disposed in an environment 302 represented by a zone map having multiple zones 330. For example, the multiple zones 330 may include a first zone 332 and a second zone 334. A user 304 may be located in one of the multiple zones 330 of the zone map and may be moving such that there is motion 306 within the multiple zones 330. The device-free motion detection system 300 is configured for device-free motion detection in that the device-free motion detection system 300 does not need a dedicated anchor or tag to determine a location of a user. At least one of the APs, such as the first access point 310, may contain motion detection functionality.

For example, the first access point 310 obtains a stream of Wi-Fi RTT distance measurements, such as by using a fine timing measurement (FTM) process, from an FTM-enabled Wi-Fi device ranging with another FTM-enabled Wi-Fi device, such as the second access point 320, typically a Wi-Fi access point. The first access point 310 performs three operations for each received measurement to make a decision as to whether motion has been detected. First, the first access point 310 determines the maximum RTT distance. For example, the first access point 310 may determine the maximum of measurements over a sliding window of length N₁. The first access point 310 may then determine the average distance before determining the ratio of the maximum to mean. For example, the first access point 310 may determine the mean of measurements over a sliding window of length N₂. If the ratio exceeds a threshold, the first access point 310 declares that motion has been detected. Otherwise, the first access point 310 makes no such declaration.

The first access point 310 obtains a stream of Wi-Fi RSSI measurements across the different antennas of a Wi-Fi device connected to another Wi-Fi device, typically a Wi-Fi access point, using signaling or frame exchange mechanisms that involve, for example, management, control, data, or other types of frames. The first access point 310 performs two operations for each received set of measurements to determine the correct zone out of a set of zones spanned by the single wireless link 340 where motion occurred. First, the first access point 310 determines, using the set of RSSI measurements, whether motion has been detected or not. For example, the first access point 310 may include variance analysis algorithms that monitor variance in the RSSI measurements over times. Additionally or alternatively, the first access point 310 may use machine learning models, such as random forest classifiers to classify variations in the RSSI measurements as motion. When motion is detected, the first access point 310 orders the RSSIs of the different antennas and uses what it learned in the past from collected data the zone where motion occurred.

The first access point 310 obtains a stream of Wi-Fi CSI and RSSI measurements across the different antennas of a Wi-Fi device connected to another Wi-Fi device, typically a Wi-Fi access point, using signaling or frame exchange mechanisms that involve, for example, management, control, data, or other types of frames. The first access point 310 selects the antennas to measure received power at and selects the subcarriers to measure the channel state. The subcarriers can be sampled uniformly across the observed spectrum, arbitrarily across the observed spectrum, or uniformly or arbitrarily across a low frequency range, or across another chunk of the spectrum.

The first access point 310 transforms a sequence of measurements, whether measurements of CSI amplitude, CSI phase, or RSSI, into a sequence of preliminary features. One such transformation is the mean, median, standard deviation, variance, or any statistic or function thereof, over a sliding window of duration T₁ seconds. A measurement can be a scalar measurement xₜ, or, if multiple subcarriers or receive antennas are sample, a vector measurement xₜ.

The first access point 310 transforms the sequence of preliminary features {vₜ} into a sequence of refined features {wₜ} by applying another transformation to the sequence, e.g., an average over of sliding window of duration T₂.

The first access point 310 stacks different feature sequences, such as CSI from different subcarriers, antennas, and RSSI from different antennas, which share a time axis, into a matrix feature or tensor feature. The first access point 310 feeds the sequence of higher-dimensional features into a supervised learning classification model, such as a random forest, decision tree, support vector machine, as training data to train the model. The first access point 310 finally deploys the trained model and performs inference on new measurements by transforming them into features with similar formatting as the training features.

Although FIG. 3 illustrates one example of a device-free motion detection and zone ambiguity resolution system, various changes may be made to FIG. 3. For example, the device-free motion detection and zone ambiguity resolution system may include more or fewer zones and more access points. Additionally, various components of FIG. 3 could be combined, further subdivided, or omitted and additional components could be added according to particular needs.

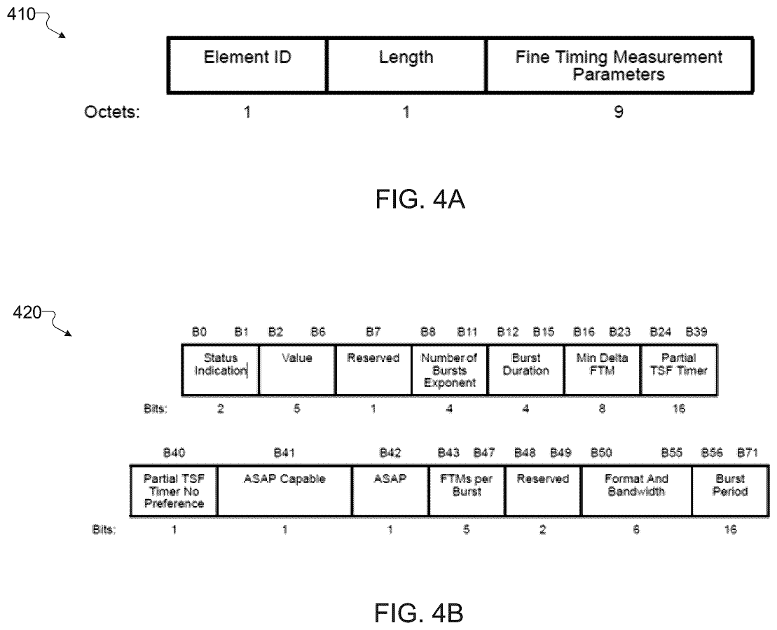

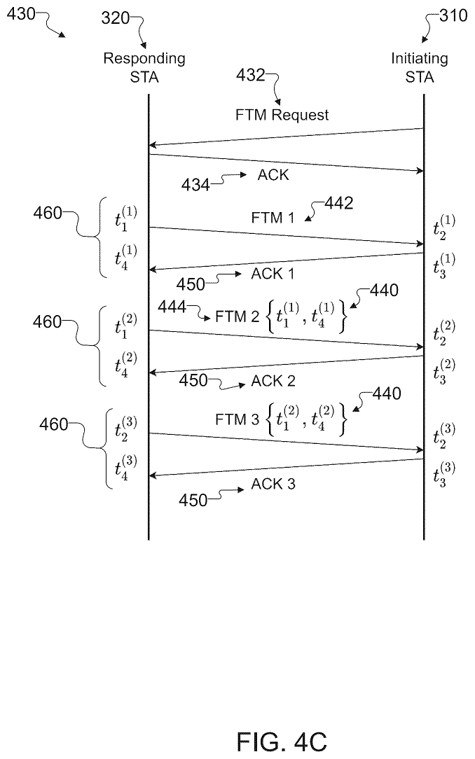

FIGS. 4A-4C illustrates an example fine timing measurement (FTM) process 400 of the device-free motion detection system 300 according to embodiments of the present disclosure. The embodiment of the FTM process 400 shown in FIGS. 4A-4C is for illustration only. Other embodiments of the FTM process 400 could be used without departing from the scope of this disclosure.

As shown in FIGS. 4A-4B, the FTM process 400 may be initiated using FTM parameter elements 410 having FTM parameter field format 420 as part an FTM trigger frame sent, for example, from the first access point 310 to the second access point 320. The FTM parameter elements 410 may include an Element ID field, a Length field, and a Fine Timing Measurement field. Additionally, the FTM parameter field format 420 may include various fields with bit sizes dependent on a desired bit length.

As shown in FIG. 4C, the FTM process 400 is a wireless network management procedure defined in IEEE 802.11-2016 (unofficially known to be defined under 802.11mc) that allows a Wi-Fi station (STA), to accurately measure the distance from other Wi-Fi nodes (e.g., STAs or APs) by measuring the round-trip time (RTT) between the two.

During the FTM process 400, the first access point 310, acting as the first access point 310, schedules an FTM session 430 with other STAs (such as the second access point 320), acting as second access point 320s, during which the STAs exchange messages and measurements. The FTM session 430 includes three phases: (i) negotiation, (ii) measurement exchange, and (iii) termination.

In the negotiation phase, the first access point 310 negotiates with the second access point 320 key parameters, such as frame format and bandwidth, number of bursts, burst duration, the burst period, and the number of measurements per burst. The negotiation starts when the first access point 310 sends an FTM request frame 432, a Management frame with subtype Action, containing the negotiated parameters and their values in the FTM parameter elements 410 of the FTM request frame 432. The second access point 320 responds with an Initial FTM frame 434 which either approves of or overwrites the parameter values provided by the first access point 310.

The measurement phase includes one or more bursts 460, and each burst includes one or more (Fine Time) measurements. The duration of a burst and the number of measurements therein are defined by the parameters burst duration and FTMs per burst. The bursts are separated by interval defined by the parameter burst duration.

During each burst 460, the second access point 320 sends the first FTM frame 442 to the first access point 310 and captures the time the first FTM frame 442 is sent as time

$${t}_{1}^{( 1 )} .$$

Upon receiving the first FTM frame 442, the first access point 310 captures the time it was received as time

$${t}_{2}^{( 1 )} .$$

The first access point 310 responds with an acknowledgment packets 450 and captures the time the acknowledgment packets 450 is sent as time

$${t}_{3}^{( 1 )} .$$

Upon receiving the acknowledgment packets 450, the second access point 320 captures the time it was received as time

$${t}_{4}^{( 1 )} .$$

The second access point 320 sends a second FTM frame 444 to The first access point 310 and captures the time it is sent

$${t}_{1}^{( 2 )} .$$

The purpose of this frame is as a follow-up to the first FTM frame 442; that is, it is used to transfer the timestamps

$${t}_{1}^{( 1 )} and {t}_{4}^{( 1 )}$$

recorded by the second access point 320. Additionally, the second FTM frame 444 starts a second measurement.

Upon receiving the second FTM frame 444, the first access point 310 extracts the timestamps

$${t}_{1}^{( 1 )} and {t}_{4}^{( 1 )}$$

and computes the RTT as:

$$RTT = ( {t}_{4}^{( 1 )} - {t}_{1}^{( 1 )} ) - ( {t}_{3}^{( 1 )} - {t}_{2}^{( 1 )} ) .$$

The first access point 310 then captures the time it was received t₂⁽²⁾.

The first access point 310 and the second access point 320 continue exchanging FTM frames and acknowledgment packets for as many measurements as there have been negotiated.

The RTT between the first access point 310 and the second access point 320 is translated into a distance using the following:

$$d = \frac{RTT}{2} c .$$

Each FTM of the burst will yield a distance sample, with multiple distance samples per burst. Given multiple FTM bursts and multiple measurements per burst, the distance samples can be combined in different ways to produce a representative distance measurement. For example, the mean distance can be reported, the median, or some other percentile. Furthermore, other statistics such as the standard deviation could be reported as well to be used by the positioning algorithm.

Although FIGS. 4A-4C illustrates one example of a fine timing measurement process, various changes may be made to FIGS. 4A-4C. For example, the FTM process may include more or fewer bursts to produce more or fewer distance measurements. Additionally, the roles of the access points or stations may be reversed (such as the second access point 320 acting as the initiating STA while the first access point 310 acts as the responding STA) according to particular needs.

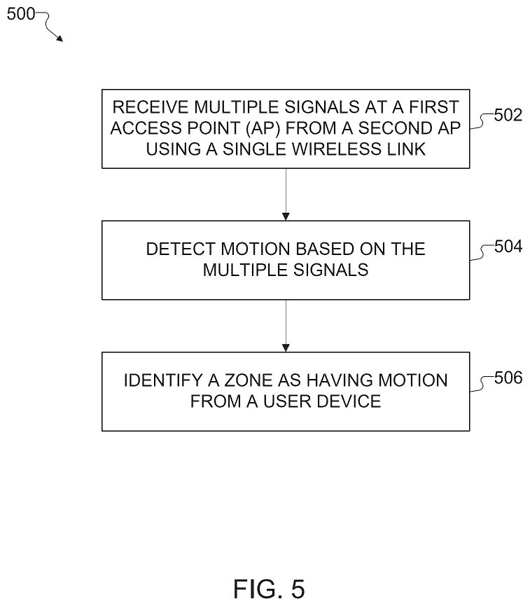

FIG. 5 illustrates an example method 500 for motion detection and zone ambiguity resolution according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of motion detection and zone ambiguity resolution could be used without departing from the scope of this disclosure.

As shown in FIG. 5, multiple signals may be received at a first access point (AP) from a second AP using a single wireless link at step 502. The multiple signals may include a Wi-Fi round-trip time (RTT), a channel state information (CSI) magnitude, a CSI phase, or a Wi-Fi RSSI. For example, the first access point 310 may initiate a fine timing measurement process 400 with the second access point 320 to determine whether motion was detected. The second access point 320 may transmit multiple signals over the single wireless link 340, which the first access point 310 receives.

Motion is detected based on the multiple signals at step 504. For example, the first access point 310 may use the multiple signals to measure a Wi-Fi round-trip time (RTT) of the signals. The first access point 310 may then determine whether a ratio of a maximum Wi-Fi RTT distance of the multiple signals to an average Wi-Fi RTT distance of the multiple signals exceeds a specified threshold. The first access point 310 may also receive data from the multiple signals that includes at least one of a channel state information (CSI) magnitude, a CSI phase, or a Wi-Fi RSSI, transforming the data into one or more preliminary features. The first access point 310 may produce one or more refined features from one or more preliminary features and generate motion detection result based on the one or more refined features using a machine learning model. For example, the first access point 310 may produce one or more refined features by transforming the data into the one or more preliminary features using a first statistical function over the sliding window and transforming the one or more preliminary features into the one or more refined features using a second statistical function over a second sliding window. The first access point 310 may produce one or more refined features from one or more preliminary features over a sliding window by stacking the one or more refined features into a matrix feature or tensor feature and generating a motion detection result based on the matrix feature or the tensor feature using a machine learning model. The machine learning model may be trained using the one or more refined features in a supervised learning classification model.

A zone is identified, using one or more Wi-Fi received signal strength indicators (RSSIs), as having motion from a user device at step 506. In particular, the one or more Wi-Fi RSSIs are used to identify a zone while resolving any zone ambiguity. For example, the first access point 310 may receive one or more Wi-Fi RSSIs from the multiple signals on the single wireless link 340. The first access point 310 may detect that a motion has occurred using a motion detection algorithm based on the one or more Wi-Fi RSSIs, sort the one or more Wi-Fi RSSIs at different antennas of the first AP and the second AP, determine an ordering for the different antennas, and determine the zone by comparing the ordering for the different antennas against a reference.

Although FIG. 5 illustrates one example method for motion detection and zone ambiguity resolution, various changes may be made to FIG. 5. For example, while shown as a series of steps, various steps in FIG. 5 may overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving multiple signals at a first access point (AP) from a second AP using a single wireless link;
detecting motion based on the multiple signals; and
identifying, using one or more Wi-Fi received signal strength indicators (RSSIs), a zone as having motion from a user device, the zone being one of multiple zones spanned by the single wireless link.

2. The method of claim 1, wherein detecting motion based on the Wi-Fi RTT of the multiple signals comprises:
determining whether a ratio of a maximum Wi-Fi round-trip time (RTT) distance of the multiple signals to an average Wi-Fi RTT distance of the multiple signals exceeds a specified threshold.

3. The method of claim 1, wherein identifying the zone comprises:
sorting the one or more Wi-Fi RSSIs at different antennas of the first AP and the second AP;
determining an ordering for the different antennas; and
determining the zone by comparing the ordering for the different antennas against a reference.

4. The method of claim 1, wherein detecting motion based on the multiple signals comprises:
receiving data from the multiple signals comprising at least one of a Wi-Fi round-trip time (RTT), a channel state information (CSI) magnitude, a CSI phase, or a Wi-Fi RSSI;
transforming the data into one or more preliminary features;
producing one or more refined features from one or more preliminary features; and
generating motion detection result based on the one or more refined features using a machine learning model.

5. The method of claim 4, wherein producing one or more refined features from one or more preliminary features over a sliding window comprises:
transforming the data into the one or more preliminary features using a first statistical function over the sliding window; and
transforming the one or more preliminary features into the one or more refined features using a second statistical function over a second sliding window.

6. The method of claim 4, wherein producing one or more refined features from one or more preliminary features over a sliding window comprises:
stacking the one or more refined features into a matrix feature or tensor feature; and
generating a motion detection result based on the matrix feature or the tensor feature using a machine learning model.

7. The method of claim 4, wherein the machine learning model is trained using the one or more refined features in a supervised learning classification model.

8. An electronic device, comprising:
a transceiver configured to receive multiple signals at a first access point (AP) from a second AP using a single wireless link; and
a processor operably coupled to the transceiver, configured to cause the electronic device to:
detect motion based on the multiple signals; and
identify, using one or more Wi-Fi received signal strength indicators (RSSIs), a zone as having motion from a user device, the zone being one of multiple zones spanned by the single wireless link.

9. The electronic device of claim 8, wherein the processor is further configured to, when causing the electronic device to detect motion based on the Wi-Fi RTT of the multiple signals, determine whether a ratio of a maximum Wi-Fi round-trip time (RTT) distance of the multiple signals to an average Wi-Fi RTT distance of the multiple signals exceeds a specified threshold.

10. The electronic device of claim 8, wherein the processor is further configured to, when causing the electronic device to identify the zone:
sort the one or more Wi-Fi RSSIs at different antennas of the first AP and the second AP;
determine an ordering for the different antennas; and
determine the zone by comparing the ordering for the different antennas against a reference.

11. The electronic device of claim 8, wherein the processor is further configured to, when causing the electronic device to detect motion based on the multiple signals:
receive data from the multiple signals comprising at least one of a Wi-Fi round-trip time (RTT), a channel state information (CSI) magnitude, a CSI phase, or a Wi-Fi RSSI;
transform the data into one or more preliminary features;
produce one or more refined features from one or more preliminary features; and
generate motion detection result based on the one or more refined features using a machine learning model.

12. The electronic device of claim 11, wherein the processor is further configured to, when causing the electronic device to produce one or more refined features from one or more preliminary features over a sliding window:
transform the data into the one or more preliminary features using a first statistical function over the sliding window; and
transform the one or more preliminary features into the one or more refined features using a second statistical function over a second sliding window.

13. The electronic device of claim 11, wherein the processor is further configured to, when causing the electronic device to produce one or more refined features from one or more preliminary features over a sliding window:
stack the one or more refined features into a matrix feature or tensor feature; and
generate a motion detection result based on the matrix feature or the tensor feature using a machine learning model.

14. The electronic device of claim 11, wherein the machine learning model is trained using the one or more refined features in a supervised learning classification model.

15. A non-transitory computer-readable medium comprising program code, that when executed by at least one processor of an electronic device, causes the electronic device to:
receive multiple signals at a first access point (AP) from a second AP using a single wireless link;
detect motion based on the multiple signals; and
identify, using one or more Wi-Fi received signal strength indicators (RSSIs), a zone as having motion from a user device, the zone being one of multiple zones spanned by the single wireless link.

16. The non-transitory computer-readable medium of claim 15, wherein the program code, that when executed by the at least one processor, causes the electronic device to detect motion based on the Wi-Fi RTT of the multiple signals, further comprises program code, further comprises program code, that when executed by the at least one processor, causes the electronic device to:
determine whether a ratio of a maximum Wi-Fi round-trip time (RTT) distance of the multiple signals to an average Wi-Fi RTT distance of the multiple signals exceeds a specified threshold.

17. The non-transitory computer-readable medium of claim 15, wherein the program code, that when executed by the at least one processor, causes the electronic device to identify the zone, further comprises program code, that when executed by the at least one processor, causes the electronic device to:
sort the one or more Wi-Fi RSSIs at different antennas of the first AP and the second AP;
determine an ordering for the different antennas; and
determine the zone by comparing the ordering for the different antennas against a reference.

18. The non-transitory computer-readable medium of claim 15, wherein the program code, that when executed by the at least one processor, causes the electronic device to detect motion based on the multiple signals, further comprises program code, that when executed by the at least one processor, causes the electronic device to:
receive data from the multiple signals comprising at least one of a Wi-Fi round-trip time (RTT), a channel state information (CSI) magnitude, a CSI phase, or a Wi-Fi RSSI;
transform the data into one or more preliminary features;
produce one or more refined features from one or more preliminary features; and
generate motion detection result based on the one or more refined features using a machine learning model.

19. The non-transitory computer-readable medium of claim 18, wherein the program code, that when executed by the at least one processor, causes the electronic device to produce one or more refined features from one or more preliminary features over a sliding window, further comprises program code, that when executed by the at least one processor, causes the electronic device to:
transform the data into the one or more preliminary features using a first statistical function over the sliding window; and
transform the one or more preliminary features into the one or more refined features using a second statistical function over a second sliding window.

20. The non-transitory computer-readable medium of claim 18, wherein the program code, that when executed by the at least one processor, causes the electronic device to produce one or more refined features from one or more preliminary features over a sliding window, further comprises program code, that when executed by the at least one processor, causes the electronic device to:
stack the one or more refined features into a matrix feature or tensor feature; and
generate a motion detection result based on the matrix feature or the tensor feature using a machine learning model, wherein the machine learning model is trained using the one or more refined features in a supervised learning classification model.
